(19) United States
(12) Patent Application Publication
(10) Pub. No.: US 2005/0169577 A1
(43) Pub. Date: Aug. 4, 2005

(54) Device for a passive module of optical gratings and communication

(75) Inventors: Chih-Liang Pan, Hsinchu (TW); Hsing-Lung Ting, Hsinchu (TW); Winyann Jang, Hsinchu (TW)

Correspondence Address: TROXELL LAW OFFICE PLLC, SUITE 1404, 5205 LEESBURG PIKE, FALLS CHURCH, VA, 22041, US

(73) Assignee: U-CONN TECHNOLOGY INC.

(21) Appl. No.: 10/770,529

(22) Filed: Feb. 4, 2004

(51) Int. Cl. G02B 6/34

(52) U.S. Cl. 385/37

(57) ABSTRACT

A device for a passive module of optical communication includes a first housing made of material with low coefficient of thermal expansion, and a second housing made of material with negative coefficient of thermal expansion. A longitudinal receiving recess is defined at the first housing for receiving the second housing, thereby effectively and accurately restraining shift of reflective central wavelength of a fiber Bragg grating (FBG) under variation of environment temperature during working. Also, A tunable mechanism including an elastic recess is formed with the first housing and a tunable member which can tune the width of the elastic recess through pressing the first housing, thereby independently switching reflective central wavelength of the FBG at desire.

### BACKGROUND OF THE INVENTION

1. Field of the Invention

The present invention relates to a passive module for an optical grating and communication, more particularly to a passive module which can switch reflective central wavelength of the FBG independently at desire and be temperature-compensated automatically under variation of environment temperature during working.

2. Prior Art

In general, as one kind of passive modules of optical communication, FBGs are widely applied to fabricate different network modules for a dense wavelength division multiplexing (DWDM), such as an amplifier, an attenuator, a multiplexer, a demultiplexer, a wavelength filter, and a coupler. The characteristic of the FBG is that the grating spacing and the refractive index of the FBG determine the central wavelength of the reflective light. Variation of temperature directly affects the refractive index and the grating spacing, which makes variation of the grating wavelength dependently and so the central wavelength is shifted. Therefore, it is an important consideration in design how to make the grating restrain variation of reflective wavelength under variation of environment temperature during working. A conventional solution to restrain the variation of the reflective wavelength is to bring tension to bear on the FBG corresponding to the variation of the temperature whereby the variation of grating spacing counteracts the variation of the refractive index. An example of the conventional solution is to provide temperature compensation through the difference between coefficients of thermal expansion of different materials for an FBG which a given tensile stress is applied to and so the FBG evenly moves with temperature change, as disclosed in U.S. Pat. Nos. 5,781,677, 5,812,711, 5,999,546, 5,999,671, 6,055,348, 6,108,470 and 6,148,128. Another example is to provide mechanical tuning to change grating spacing of an FBG through a tunable mechanism, as disclosed in U.S. Pat. Nos. 6,055,348, 6,154,590, 6,327,405, 6,374,015 and 6,396,982.

However, the prior art just has the functions on tuning temperature-compensated. It cannot provide both switching reflective central wavelength of the FBG independently at desire and tuning temperature-compensated automatically under variation of environment temperature during working. Thus it is necessary to improve and conform with more tough working environment.

### SUMMARY OF THE INVENTION

Accordingly, an object of the present invention is to provide a device for a passive module of an optical grating and communication which has functions of automatic temperature compensation at variation of environment temperature and independently switching reflective central wavelength of the FBG at desire, thereby freely controlling reflective central wavelength of an FBG and effectively and accurately restraining shift of reflective central wavelength of the FBG

To achieve the above-mentioned object, a device for a passive module of optical communication in accordance with the present invention includes a first housing made of material with low coefficient of thermal expansion, and a second housing made of material with negative coefficient of thermal expansion. A longitudinal receiving recess is defined at the first housing for receiving the second housing. A tunable mechanism including an elastic recess is formed with the first housing and a tunable member which is able to tune the width of the elastic recess through pressing the first housing. A groove is defined near the elastic recess in the first housing for receiving an end of the FBG. A slot is longitudinally defined in the second housing for receiving another end of the FBG.

Other objects, advantages and novel features of the present invention will be drawn from the following detailed embodiments of the present invention with attached drawings, in which:

### BRIEF DESCRIPTION OF THE DRAWINGS

FIG. 1 is a perspective view of a device for a passive module of optical communication in accordance with an embodiment of the present invention;

FIG. 2 is a top plan view of FIG. 1;

FIG. 3 is a front elevation view of FIG. 1 and tuning showed by the broken line;

FIG. 4 is similar to FIG. 3 but showing status of automatic compensation when temperature rises;

FIG. 5 is similar to FIG. 3 but showing automatic compensation when temperature lowers; and

FIG. 6 is a perspective view of a device for a passive module of optical communication in accordance with an alternative embodiment of the present invention.

### DESCRIPTION OF THE PREFERRED EMBODIMENTS

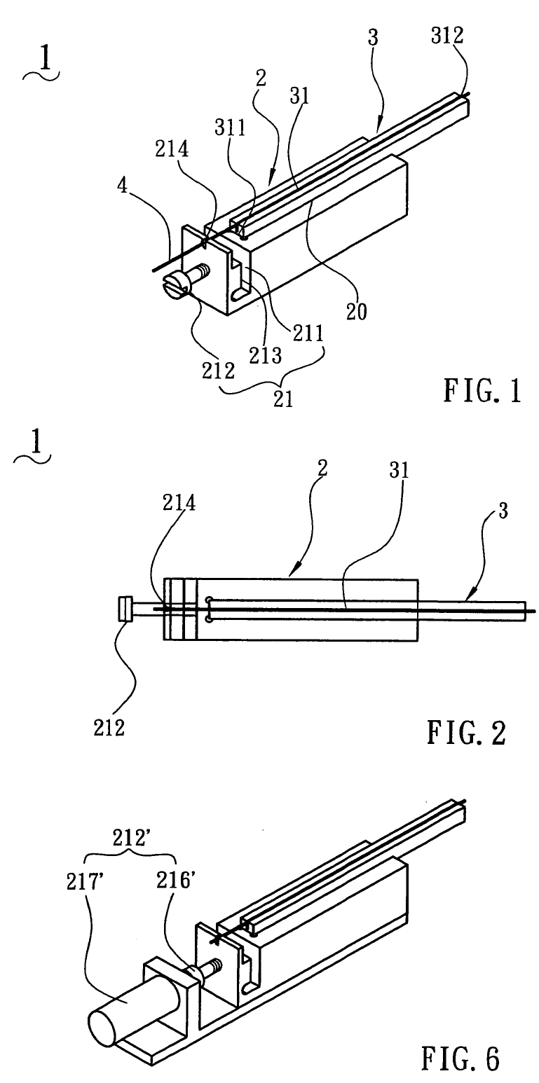

Referring to FIGS. 1-2, a device 1 for a passive module of optical communication of the present invention is used to freely control reflective central wavelength of FBG and effectively and accurately restrain shift of reflective wavelength of the FBG, and includes a first housing 2 and a second housings 3 attached to the first housing 2. The first housing 2 made of material with low coefficient of thermal expansion, such as Kovar, is generally rectangular with four longitudinal surfaces and two lateral surfaces. A longitudinal receiving recess 20 is defined at the upper longitudinal surface of the first housing 2, extending from one of the lateral surfaces for receiving the second housing 3. A tunable mechanism 21 is integrally formed with the other lateral surface and is generally L-shaped with a lateral sidewall and a longitudinal bottom wall connected with the sidewall. An elastic recess 211 is defined between the other lateral surface of the first housing 2 and the sidewall of the tunable mechanism 21 and is generally U-shaped. A protrusion 213 extends from the sidewall of the tunable mechanism 21 into the elastic recess 211 for enhancing the sidewall. A screw hole 215 is defined through the sidewall and the protrusion 213. The tunable mechanism 21 also includes a tunable member 212 threadedly engaging with the screw hole 215. The protrusion 213 increases the depth of the screw hole 215 and thus increases the length of the thread of the screw hole 215 thereby enhancing the engagement between the tunable member 212 and the screw hole 215 and also increasing tunable scope of the tunable mechanism 21. In addition, a groove 214 is defined in the top of the sidewall of the tunable mechanism 21 for fixing an end of the FBG 4. The tunable member 212 which is a screw in this embodiment engagingly extends through the screw hole 215 and abuts against the other lateral surface of the first housing 2 whereby the width of the elastic recess 211 is tunable through the tunable member 212 pressing the first housing 2. As shown in FIG. 6, in an alternative embodiment of the present invention, the tunable member 212′ further includes a clutch 216′ and an actuator 217′ pivotally connected with the clutch 216′ thereby automatically tuning the width of the elastic recess 211 through a control circuit.

The second housing 3 which is made of material with negative coefficient of thermal expansion, such as ceramic, have an end 311 further fitted near the elastic recess 211 in the receiving recess 20 of the first housing 2 by agglutinant. A slot 31 is longitudinally defined in the upper surface of the second housing 3 for receiving the other end of the FBG 4. When the FBG 4 is assembled to be received in the groove 214 and the slot 31, the FBG 4 is pre-stressed by tension to make central wavelength of reflective light fall within a desired range and then fixed in the groove 214 and an end 312 of the slot 31 by bonds. The width of the groove 214 and the slot 31 is preferred to be equal to the diameter of the FBG 4 for preventing from affecting the shrinkage of temperature compensation.

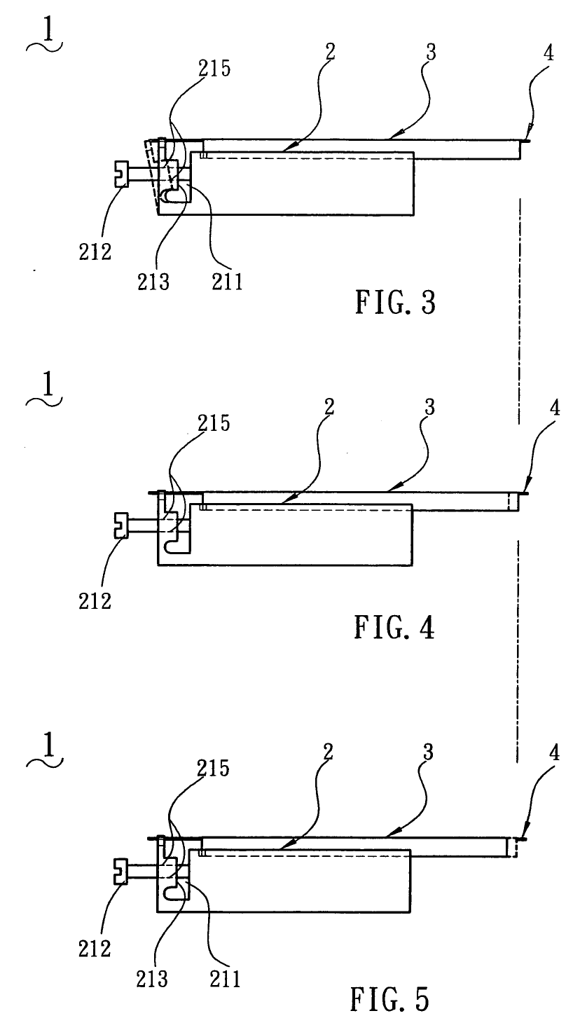

Referring to FIG. 3, the device 1 for a passive module of optical communication is assembled with the FBG 4. When the circumstance temperature rises, the length of the second housing 3 will be longitudinally reduced due to the negative coefficient of thermal expansion thereof whereby the FBG 4 is shrunk toward one end thereof, as shown by the broken line in FIG. 4. When the circumstance temperature lowers, the length of the second housing 3 will be longitudinally increased due to the negative coefficient of thermal expansion thereof whereby the FBG 4 expands toward the end thereof, as shown by the broken line in FIG. 5. Therefore, the second housing 3 with the negative coefficient of thermal expansion makes the combined contribution of variations in the grating spacing and the refractive index with the temperaturelimited to a desired value thereby restraining the shift of reflective central wavelength of the FBG 4. When it is desired to independently tune the reflective wavelength position and switch among different channels, the reflective wavelength is tuned through the tunable member 212 which is able to tune the width of the elastic recess 211, as shown by the broken line in FIG. 3, thereby tuning the wavelength position and switching to other channel. The compensation is proved by the following formulas.

$$\frac{Δ {λ}_{B}}{{λ}_{B}} = [ \frac{1}{Λ} \frac{\partial Λ}{\partial T} + \frac{1}{n} \frac{\partial n}{\partial T} ] Δ T = [ {α}_{f} + \frac{1}{n} \frac{\partial n}{\partial T} ] Δ T \qquad ( 1 )$$

wherein Λ is grating spacing, n is an effective refractive index, α_{f} is a coefficient of thermal expansion of a fiber. For consideration of the tunable mechanism of the present invention, formula (2) is derived from formula (1) and is shown as follows.

$$\frac{Δ {λ}_{B}}{{λ}_{B}} = [ {α}_{f} + \frac{1}{n} \frac{\partial n}{\partial T} + \frac{{L}_{1}}{{L}_{1} + {L}_{2}} {α}_{1} + \frac{{L}_{2}}{{L}_{1} + {L}_{2}} {α}_{2} ] Δ T \qquad ( 2 )$$

wherein α₁ and L₁ are respectively the coefficient of thermal expansion and the length of the first housing 2, and α_{2 and L}₂ are respectively the coefficient of thermal expansion and the length of the second housing 3. If it is desired to maintain Δλ_{B} to equal to 0, that is, the reflective wavelength is not shifted, and formula (3) is derived as follows.

$${α}_{f} + \frac{1}{n} \frac{\partial n}{\partial T} + \frac{{L}_{1}}{{L}_{1} + {L}_{2}} {α}_{1} + \frac{{L}_{2}}{{L}_{1} + {L}_{2}} {α}_{2} = 0 ⇒ {α}_{2} = - \frac{[ ( \frac{\partial n}{\partial T} + n {α}_{f} ) ( {L}_{1} + {L}_{2} ) + n {α}_{1} {L}_{1} ]}{n {L}_{2}} \qquad ( 3 )$$

Therefore, coefficients of thermal expansion for α1 and α2 is calculated via the above formulas. The desired coefficients of thermal expansion depend on combination of L₁ and L₂.

Thus, the compensating device 1 for a passive module of optical communication of the present invention is able to independently tune reflective central wavelength of the FBG, switch channels and be automatically temperature-compensated for restraining shift of reflective wavelength of the FBG 4, through the first housing 2 with low efficient of thermal expansion, the second housing 3 with negative efficient of thermal expansion and the tunable mechanism. Furthermore, when the function of independently tuning and switching channels is not used, the compensating device 1 still has the function of automatically temperature-compensated.

It is understood that the invention may be embodied in other forms without departing from the spirit thereof. Thus, the present examples and embodiments are to be considered in all respects as illustrative and not restrictive, and the invention is not to be limited to the details given herein.

1. A device for a passive module of optical gratings and communication, comprising:
a first housing made of material with low coefficient of thermal expansion, a longitudinal receiving recess being defined at the first housing, a tunable mechanism including an elastic recess is formed with the first housing and a tunable member which can tune width of the elastic recess through pressing the first housing, a groove is defined near the elastic recess in the first housing for receiving an end of the FBG;
a second housing made of material with negative coefficient of thermal expansion and received in the receiving recess of the first housing, a slot being longitudinally defined in the second housing for receiving another end of the FBG.

2. The device for a passive module of optical gratings and communication as claimed in claim 1, wherein the first housing is generally rectangular with four longitudinal surfaces and two lateral surfaces.

3. The device for a passive module of optical gratings and communication as claimed in claim 2, wherein the longitudinal receiving recess is defined at the upper longitudinal surface of the first housing, extending from one of the lateral surfaces.

4. The device for a passive module of optical gratings and communication as claimed in claim 3, wherein the second housing is fittingly received in the receiving recess of the first housing, and further fitted near the elastic recess in the receiving recess of the first housing by agglutinant.

5. The device for a passive module of optical gratings and communication as claimed in claim 4, wherein the tunable mechanism is integrally formed with the other lateral surface and is generally L-shaped with a lateral sidewall and a longitudinal bottom wall connected with the sidewall, and wherein the elastic recess is defined between the other lateral surface of the first housing and the sidewall of the tunable mechanism and is generally U-shaped.

6. The device for a passive module of optical gratings and communication as claimed in claim 5, wherein the second housing projects from the upper surface of the first housing.

7. The device for a passive module of optical gratings and communication as claimed in claim 6, wherein the sidewall of the tunable mechanism projects from the upper surface of the first housing and is substantially at the same height as the second housing.

8. The device for a passive module of optical gratings and communication as claimed in claim 7, wherein a protrusion extends from the sidewall of the tunable mechanism into the elastic recess, and a screw hole is defined through the sidewall and the protrusion.

9. The device for a passive module of optical gratings and communication as claimed in claim 8, wherein the tunable member is a screw which engagingly extends through the screw hole and abuts against the other lateral surface of the first housing whereby the width of the elastic recess is tunable through the tunable member pressing the first housing.

10. The device for a passive module of optical gratings and communication as claimed in claim 1, wherein the first housing is made of Kovar.

11. The device for a passive module of optical gratings and communication as claimed in claim 1, wherein the second housing is made of ceramic.

12. The device for a passive module of optical gratings and communication as claimed in claim 1, wherein the FBG is fixed in the groove and an end of the slot by agglutinant.

13. The device for a passive module of optical gratings and communication as claimed in claim 8, wherein the width of the groove and the slot is substantially equal to the diameter of the FBG.

14. The device for a passive module of optical gratings and communication as claimed in claim 7, wherein the tunable member further includes a clutch and an actuator connected with the clutch thereby automatically tuning the width of the elastic recess.
